(19) United States
(12) Patent Application Publication
(10) Pub. No.: US 2011/0133912 A1
(43) Pub. Date: Jun. 9, 2011

(54) Parking and Long Distance Remote Vehicle Disabler

(76) Inventor: Nestor A. TESMAN, West Palm Beach, FL (US)

(21) Appl. No.: 12/964,401

(22) Filed: Dec. 9, 2010

Related U.S. Application Data
(60) Provisional application No. 61/285,023, filed on Dec. 9, 2009.

(51) Int. Cl. B60R 25/04

(52) U.S. Cl. 340/426.12

(57) ABSTRACT

A vehicle disabling device with a remote control able to wirelessly disable an essential component of a vehicle. The essential component of the vehicle is required to maintain the normal operation of the vehicle. The present invention is able to help prevent car thefts by stopping the vehicle from driving away or disabling the vehicle when it is parked. The present inventions can be used by car owners and enforcement officers.

The current application claims a priority to the U.S. Provisional Patent application Ser. No. 61/285,023 filed on Dec. 9, 2009.

### FIELD OF THE INVENTION

The present invention relates generally to a device that allows users to disable the use of any vehicle including cars, police cars, school bus, 18 wheelers, trucks, RV's, motorcycles, boats, etc. when is parked or while is running from a long distance using a remote control and receiver. More specifically, the present invention can be used by vehicle owners or law enforcement officials to stop vehicle theft.

### BACKGROUND OF THE INVENTION

Currently, an average of almost eight hundred thousand vehicle thefts occurs in a year. This means that every 40 seconds a car is being stolen. A survey of American drivers conducted showed that one third of the drivers admitted to leaving their vehicles while leaving the car running, making the vehicle an easy target for theft. A large percentage of drivers admit to not parking their cars in well lit areas or not concealing their valuables in the car. Among the stolen vehicles only about 12 percent of the thefts were cleared. The national insurance crime bureau has found that technology such as license plate readers, owner-installed theft deterrent devices, and tracking/recovering systems significantly aided the recovery of stolen vehicles. The present invention aims to address the issue of vehicle theft by introducing a theft deterrent device that is able to disable a vehicle. The present invention disables a vehicle while ignition is running or prevents a vehicle from activated by using a remote control to disable an essential component. Also disables a vehicle while is parked. The present invention comprises of a disabling device that is connected to the essential component that is required to maintain the ignition of the engine. The disabling device can be connected to components such as the distributor or to the ignition coil. The device uses a transmitter controlled by two simple buttons which transmits the signal to the disabling device installed in the vehicle. Upon receiving the signal from the transmitter, the receiver of the disabling device cuts off power to the essential component and therefore immediately disables the vehicle while is running or while the vehicle is parked, in this case the vehicle can not be able to turning on still with the vehicle keys.

### BRIEF DESCRIPTION OF THE DRAWINGS

FIG. 1 is a perspective view of the remote control and the vehicle disabling device of the present invention.

FIG. 2 is a front elevational view of the vehicle disabling device.

FIG. 3 is a perspective view of the remote control with the slide cover in a closed position.

FIG. 4 is a rear elevational view of the remote control.

FIG. 5 is a rear exploded view of the remote control showing the remote battery and compartment.

FIG. 6 is a schematic diagram of the remote control deactivating the vehicle disabling device to allow normal functionality of the essential vehicle component.

FIG. 7 is a schematic diagram of the remote control activating the vehicle enabling device to take away the functionality of the essential vehicle component.

### DETAIL DESCRIPTIONS OF THE INVENTION

All illustrations of the drawings are for the purpose of describing selected versions of the present invention and are not intended to limit the scope of the present invention.

The present invention is a vehicle disabling apparatus comprising of a vehicle disabling device 9 and a remote control 1. The remote control 1 and the vehicle disabling device 9 are able to communicate by means of wireless radio frequency signals. The vehicle disabling device 9 is a device that is installed into a vehicle being connected to an essential vehicle component 18. The essential vehicle component 18 is a component that is required to maintain operation of a vehicle's engine. The remote control 1 is able send wireless signals to enable the vehicle disabling device 9 to cut off power to and cease the functionality of the essential vehicle component 18. The remote control 1 is also able to send wireless signals to disable the vehicle disabling device 9 to restore functionality to the essential vehicle component 18. To do so, the remote control 1 comprises of a remote antenna 2, a transmitter 3, a disable button 4, an enable button 5, a slide cover 6, a remote casing 7, and a remote battery 8.

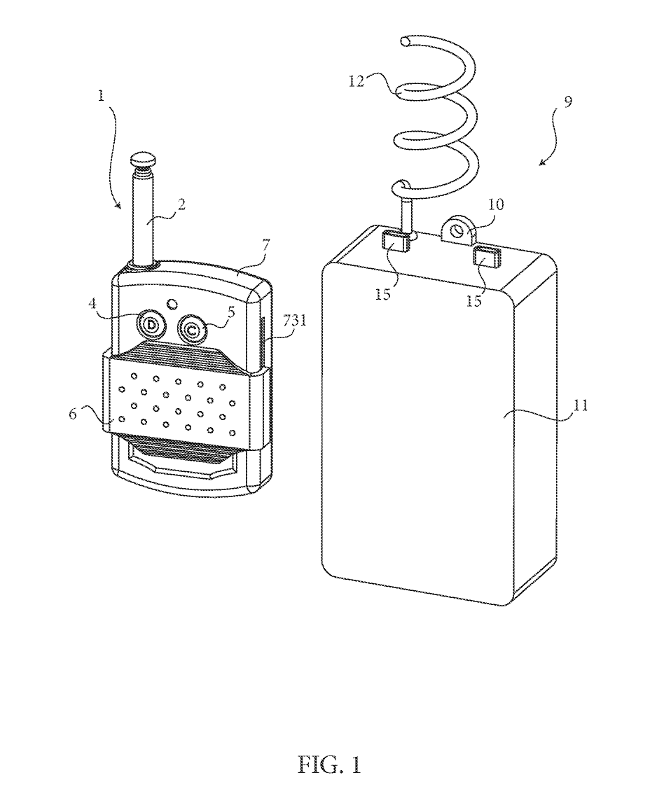

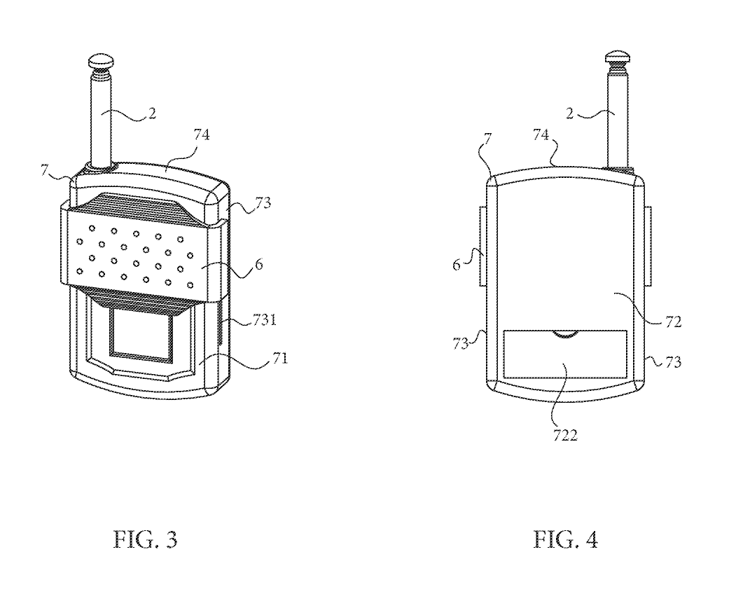

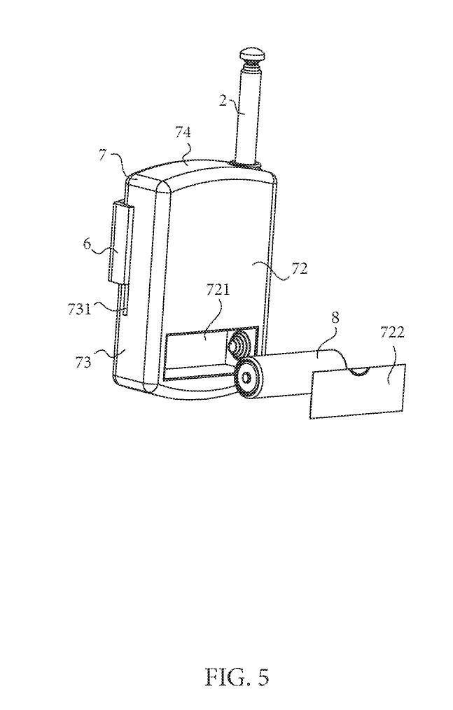

In reference to FIG. 1 and FIG. 3-7, remote casing 7 is able to contain all of the components of the remote control 1 together. The remote casing 7 has a front face 71, a back face 72, side edges 73, and a top edge 74. The transmitter 3 is positioned and secured in the interior space inside the remote casing 7. The transmitter 3 is a radio frequency transmitter 3 able to emit an encoded radio frequency of a customized frequency. The transmitter 3 communicates with the vehicle disabling device 9. To ensure the radio frequency signal reaches the vehicle disabling device 9 the transmitter 3 is connected to the remote antenna 2. The remote antenna 2 protrudes and extends from the top edge 74 of the remote casing 7. The remote antenna 2 helps the transmitter 3 amplify and emit an encoded radio frequency signal. In the preferred embodiment of the present invention, the remote antenna 2 is a telescopic antenna. The telescopic antenna allows the remote control 1 to be more portable. Additionally, with a telescopic antenna the signal that the remote control 1 can emit is optimized for maximum distance. This allows the remote control 1 to communicate with the vehicle disabling device 9 at a long distance. In the preferred embodiment of the present invention, the remote control 1 can send a signal to the vehicle disabling device 9 up to 1200 feet. For the transmitter 3 to emit the encoded radio frequency signal, the transmitter 3 is connected and powered by the remote battery 8. The back face 72 comprises of a battery compartment 721 and a battery cover 722. The battery compartment 721 is a recessed circular space positioned on the back face 72 of the remote control 1. The remote battery 8 is placed and secured in the battery compartment 721 by the battery cover 722. The battery cover 722 is secured to the battery compartment 721 by means of a snap-latch. To release the battery cover 722 from the battery compartment 721, the battery cover 722 comprises of a pull tab. The battery compartment 721 comprises of leads that allow the battery to power the other internal components of the remote control 1. The disable button 4 and the enable button 5 are positioned on the front face 71 of the remote control 1. In the preferred embodiment of the present invention, the disable button 4 and the enable button 5 are positioned adjacent to each other. The disable button 4 is connected to the transmitter 3 to give the transmitter 3 the command to emit a wireless signal to disable the vehicle disabling device 9. The enable button 5 is connected to the transmitter 3 to give the transmitter 3 the command to emit a wireless signal to enable the vehicle disabling device 9. On the side edges 73 of the remote casing 7 are slide cover tracks 731. The slide cover tracks 731 are indented grooves positioned on both side edges 73 of the remote casing 7 that are arranged in a co-linear fashion with the height of the remote casing 7. The slide cover tracks 731 allow for the securing of the slide cover 6. The slide cover 6 is attached across the front face 71 of the remote casing 7 and connects to the slide cover tracks 731. The slide cover 6 is able to traverse the length of the slide cover track to cover or expose the disable button 4 and the enable button 5 of the remote control 1. This is to prevent the accidental activation of a vehicle when the user is driving a vehicle that has the vehicle disabling device 9 installed. For example, a user may be carrying the remote control 1 in a pocket with keys. When the user is driving the vehicle, a slight shift may cause the keys to press against the disable button 4 to disable the vehicle. To prevent this from happening, the slide cover 6 provides a barrier that allows users to avoid having the remote control 1 from sending a signal to the vehicle disabling device 9 to disable the vehicle. In case of an emergency that requires the use of the remote control 1, the user can simply slide the slide cover 6 to reveal the disable button 4 and the enable button 5.

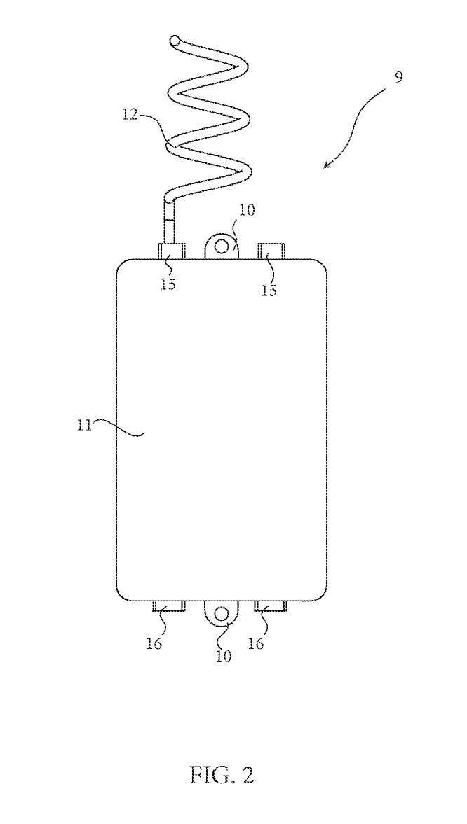

In reference to FIG. 1-2 and FIG. 6-7, the vehicle disabling device 9 comprises of a pair of mounting eyelets 10, a device casing 11, a device antenna 12, a RF receiver 13, a switch 14, power lead connectors 15, power port connectors 16, and a fuse 17. The device casing 11 is the main body of the vehicle disabling device 9 that is able to contain all of the other components. To connect and secure the vehicle disabling device 9 to a vehicle, the user is able to use fasteners through the pair of mounting a pair of mounting eyelets 10 on to a surface of the interior of the vehicle. The pair of mounting a pair of mounting eyelets 10 protrudes from the sides of the device casing 11 and comprises of holes that allow fasteners to secure the device. The vehicle disabling device 9 is an intermediate device that is able to cut power off to the essential vehicle component 18 of the vehicle. The vehicle disabling device 9 is first connected to a vehicle battery 19 by the power port connectors 16. The vehicle disabling device 9 is powered by the vehicle battery 19 through the power port connectors 16. The power ports 16 of the vehicle disabling devices 9 comprises of a positive port connector 161, a negative port connectors 162, a positive port 163, and a negative port 164. The power ports 16 is connected to the vehicle battery 19 by means of the connection of the positive port 163 and the negative port 164 to the positive terminal and the negative terminal of the vehicle battery 19 with the positive port connector 161 and the negative port connector 162, respectively. To protect the vehicle disabling device 9 from surges, the fuse 17 is connected in line with the positive port connector 161. The fuse 17 protects the functionality of the vehicle disabling device 9. The user is able to connect the vehicle disabling device 9 to the essential vehicle component 18 by means of the power lead connectors 15. The power lead connectors 15 are extended from the device casing 11 allowing the vehicle disabling device 9 to act as one of the polar power connectors for the essential vehicle component 18. The essential vehicle component is powered by the vehicle electric system 20. The power lead connectors 15 can act as the negative lead connector or the positive lead connector for the essential vehicle component 18 with the vehicle disabling device 9 as an in line intermediate device. The switch 14 of vehicle disabling device 9 is normally closed to allow power from the vehicle electric system 20 to make its way through the power lead connectors 15 to the essential vehicle component 18 for regular operation. The switch 14 of the vehicle disabling device 9 is the component that is able to disable the essential vehicle component 18. The switch 14 is positioned inside the device casing 11 and is normally closed. The essential vehicle component 18 is a component of the vehicle which is required to continually maintain the ignition of the engine. The essential vehicle component can be any car part selected from a distributor, ignition coil, fuel pump, or fuel injector. When electrical power is cut off from any essential vehicle component, the engine will not be able to maintain functionality. When the vehicle disabling device 9 is deactivated, the switch 14 is turned to or remains in its normally closed position to complete the circuit for normal functionality of the essential vehicle component 18. When the vehicle disabling device 9 is activated, the switch 14 is flipped to an open position to cut off power flow to the essential vehicle component 18 through the power lead connectors 15. For the switch 14 to cut off power flow from the vehicle electric system 20 to the power lead connectors 15, the switch 14 is connected in line with the power lead connectors 15. With the power lead connectors 15 being connected to the vehicle electric system 20 and the essential vehicle component 18, the switch is able to break current to the essential vehicle component 18. The power lead connectors comprise of an electric system connector 151 and a vehicle component connector 152. The electric system connector 151 connects the vehicle electric system 20 to the switch 14. The vehicle component connector 152 connects the essential vehicle component 18 to the terminal of the switch 14 opposite of the electric system connector 151. The switch 14 is also connected to the RF receiver 13 and receives the command to open or close. The RF receiver 13 is the component of the vehicle disabling device 9 that is able to receive the encoded radio frequency signal that is emitted by the transmitter 3. To ensure that the vehicle disabling device 9 is able to effectively receive the encoded signal the RF receiver 13 is connected to a device antenna 12. The RF receiver 13 is positioned inside the interior space of the device casing 11. The device antenna 12 protrudes and extends from the device casing 11. The device antenna 12 is able to capture the wireless signal emitted by the remote control 1 and allow the RF receiver 13 to receive the signal.

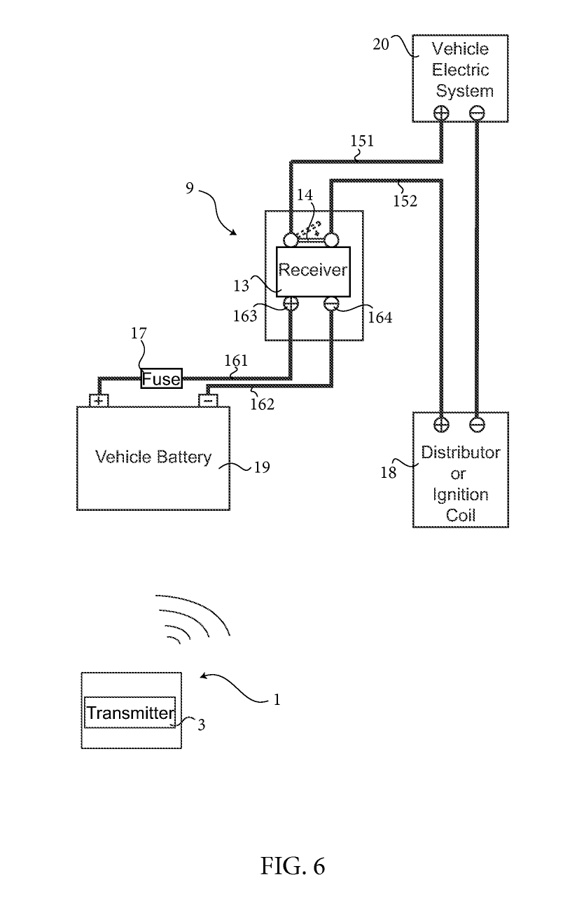

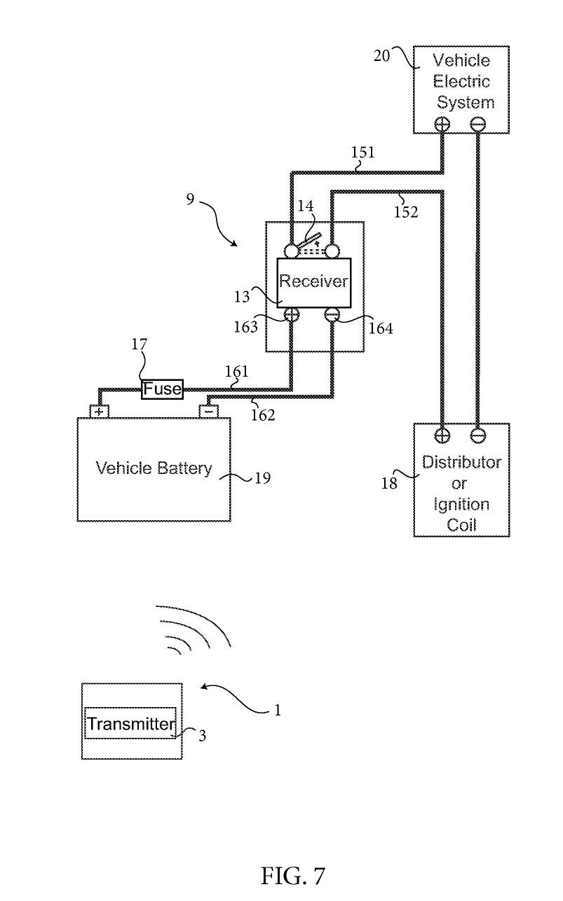

In reference to FIG. 6-7, when the user presses the disable button 4 on the remote control 1, the transmitter 3 will emit an encoded signal through the remote antenna 2 to activate the vehicle disabling device 9 to disable the vehicle. The device antenna 12 of the vehicle disabling device 9 will be able to detect the emitted encoded signal from the transmitter 3 and relay it to the RF receiver 13. The RF receiver 13 will receive the encoded signal to activate the vehicle disabling device 9 and command the switch 14 to open. The activation of the vehicle disabling device 9 places the switch 14 at an open position to cut off power to an essential component of the vehicle. The activation of the vehicle disabling device 9 disables the functionality of the vehicle. The disable button 4 directly correlates to the disabling of the vehicle. When the user presses the enable button 5 on the remote control 1, the transmitter 3 will emit an encoded signal through the remote antenna 2 to deactivate the vehicle disabling device 9 to allow normal functionality of the vehicle. The device antenna 12 of the vehicle disabling device 9 will detect the emitted signal from the transmitter 3 and relay it to the RF receiver 13. The RF receiver 13 will then receive the encoded signal to deactivate the vehicle disabling device 9 and command the switch 14 to return to the normally closed position. The deactivation of the vehicle disabling device 9 returns the switch 14 to a closed position to restore the original functionality of the essential vehicle component 18. The deactivating of the vehicle disabling device 9 resumes the original functionality of the vehicle. The enabling button 5 directly correlates to the enabling of the vehicle.

In cases that the user loses or damages the remote control 1 and the vehicle disabling device 9 is activated (switch 14 is open), the user can still deactivate the vehicle disabling device 9 manually. The switch 14 of the vehicle disabling device 9 being normally closed and require power to maintain an open position can be reset into the closed position. To manually reset the switch 14 into the closed position, the user can simply disconnect and reconnect the power port connector to the vehicle disabling device. The disconnection of the power port connector for 3 seconds will reset the switch 14 into its normally closed position. The power port connector can be the positive port connector 161 or the negative port connector 162.

Although the invention has been explained in relation to its preferred embodiment, it is to be understood that many other possible modifications and variations can be made without departing from the spirit and scope of the invention as hereinafter claimed.

What is claimed is:

1. A Parking and Long Distance Remote Vehicle Disabler comprises,
a remote control;
a vehicle disabling device;
a essential vehicle component;
a vehicle battery;
a vehicle electric system
the remote control comprises of a transmitter, a remote antenna, a disable button, an enable button, a slide cover, a remote battery, and a remote casing; and
the vehicle disabling device comprises of a pair of mounting eyelets, a device casing, a RF receiver, a device antenna, a switch, a power leads connector, a power port, and a fuse.

2. The Parking and Long Distance Remote Vehicle Disabler as claimed in claim 1 comprises,
the remote casing having a front face, a back face, side edges, and a top edge;
the transmitter being positioned inside the remote casing;
the transmitter being connected to the remote antenna;
the remote antenna being extended from the top edge of the remote casing; and
the transmitter being connected to the remote battery.

3. The Parking and Long Distance Remote Vehicle Disabler as claimed in claim 2 comprises,
the disable button being positioned on the front face of the remote casing;
the enable button being positioned on the front face of the remote casing adjacent to the disable button;
the disable button being connected to the transmitter; and
the enable button being connected to the transmitter.

4. The Parking and Long Distance Remote Vehicle Disabler as claimed in claim 3 comprises,
the side edges comprise of slide cover tracks;
the slide cover tracks being long grooves positioned in collinear relationship with the side edges;
the slide cover being positioned across the front face of the remote casing; and
the slide cover being secured to the slide cover tracks of the side edges.

5. The Parking and Long Distance Remote Vehicle Disabler as claimed in claim 4 comprises,
the back face comprises of a battery compartment and a battery cover;
the battery compartment being a recessed space positioned on the back face;
the remote battery being positioned and secured in the battery compartment by the battery cover; and
the transmitter being connected to and powered by the remote battery.

6. The Parking and Long Distance Remote Vehicle Disabler as claimed in claim 1 comprises,
the power ports comprises of a positive port connector, a negative port connector, a positive port, and a negative port;
the RF receiver being positioned inside the device casing;
the switch being positioned inside the device casing; and
the switch being connected to the RF receiver.

7. The Parking and Long Distance Remote Vehicle Disabler as claimed in claim 6 comprises,
the switch being connected in line with the power leads connectors;
the positive port being connected to the vehicle battery by means of the positive port connector;
the negative port being connected to the vehicle battery by means of the negative port connector;
the vehicle battery powering the vehicle disabling device;
the fuse being connected in line with the positive port connector;
the vehicle electric system being connected to the switch by means of the electric system connector; and
the essential vehicle component being connected to the switch by means of the vehicle component connector.

8. The Parking and Long Distance Remote Vehicle Disabler as claimed in claim 7 comprises,
the device antenna being connected to the RF receiver and being extended from the device casing;
the power lead connecters being extended from the device casing;
a pair of mounting eyelets protruding from the device casing; and
the essential vehicle component being a car part selected from the group consisting of a distributor, ignition coil, fuel pump, and fuel injector.

9. A Parking and Long Distance Remote Vehicle Disabler comprises,
a remote control;
a vehicle disabling device;
a essential vehicle component;
a vehicle battery;
a vehicle electric system
the remote control comprises of a transmitter, a remote antenna, a disable button, an enable button, a slide cover, a remote battery, and a remote casing;
the vehicle disabling device comprises of a pair of mounting eyelets, a device casing, a RF receiver, a device antenna, a switch, a power leads connector, a power port, and a fuse;
the remote casing having a front face, a back face, side edges, and a top edge;
the transmitter being positioned inside the remote casing;
the transmitter being connected to the remote antenna;
the remote antenna being extended from the top edge of the remote casing;
the transmitter being connected to the remote battery; and
the power ports comprises of a positive port connector, a negative port connector, a positive port, and a negative port.

10. The Parking and Long Distance Remote Vehicle Disabler as claimed in claim 9 comprises,
the disable button being positioned on the front face of the remote casing;
the enable button being positioned on the front face of the remote casing adjacent to the disable button;
the disable button being connected to the transmitter; and
the enable button being connected to the transmitter.

11. The Parking and Long Distance Remote Vehicle Disabler as claimed in claim 9 comprises,
the side edges comprise of slide cover tracks;
the slide cover tracks being long grooves positioned in collinear relationship with the side edges;
the slide cover being positioned across the front face of the remote casing; and
the slide cover being secured to the slide cover tracks of the side edges.

12. The Parking and Long Distance Remote Vehicle Disabler as claimed in claim 9 comprises,
the back face comprises of a battery compartment and a battery cover;
the battery compartment being a recessed space positioned on the back face;
the remote battery being positioned and secured in the battery compartment by the battery cover; and
the transmitter being connected to and powered by the remote battery.

13. The Parking and Long Distance Remote Vehicle Disabler as claimed in claim 9 comprises,
the RF receiver being positioned inside the device casing;
the switch being positioned inside the device casing; and
the switch being connected to the RF receiver.

14. The Parking and Long Distance Remote Vehicle Disabler as claimed in claim 9 comprises,
the switch being connected in line with the power leads connectors;
the positive port being connected to the vehicle battery by means of the positive port connector;
the negative port being connected to the vehicle battery by means of the negative port connector;
the vehicle battery powering the vehicle disabling device;
the fuse being connected in line with the positive port connector;
the vehicle electric system being connected to the switch by means of the electric system connector; and
the essential vehicle component being connected to the switch by means of the vehicle component connector.

15. The Parking and Long Distance Remote Vehicle Disabler as claimed in claim 9 comprises,
the device antenna being connected to the RF receiver and being extended from the device casing;
the power lead connecters being extended from the device casing;
a pair of mounting eyelets protruding from the device casing; and
the essential vehicle component being a car part selected from the group consisting of a distributor, ignition coil, fuel pump, and fuel injector.

16. A Parking and Long Distance Remote Vehicle Disabler comprises,
a remote control;
a vehicle disabling device;
a essential vehicle component;
a vehicle battery;
a vehicle electric system
the remote control comprises of a transmitter, a remote antenna, a disable button, an enable button, a slide cover, a remote battery, and a remote casing;
the vehicle disabling device comprises of a pair of mounting eyelets, a device casing, a RF receiver, a device antenna, a switch, a power leads connector, a power port, and a fuse;
the remote casing having a front face, a back face, side edges, and a top edge;
the transmitter being positioned inside the remote casing;
the transmitter being connected to the remote antenna;
the remote antenna being extended from the top edge of the remote casing;
the transmitter being connected to the remote battery;
the power ports comprises of a positive port connector, a negative port connector, a positive port, and a negative port;
the switch being connected in line with the power leads connectors;
the positive port being connected to the vehicle battery by means of the positive port connector;
the negative port being connected to the vehicle battery by means of the negative port connector;
the vehicle battery powering the vehicle disabling device;
the fuse being connected in line with the positive port connector;
the vehicle electric system being connected to the switch by means of the electric system connector;
the essential vehicle component being connected to the switch by means of the vehicle component connector;
the side edges comprise of slide cover tracks;
the slide cover tracks being long grooves positioned in collinear relationship with the side edges;
the slide cover being positioned across the front face of the remote casing;
the slide cover being secured to the slide cover tracks of the side edges; and
the device antenna being connected to the RF receiver and being extended from the device casing.

17. The Parking and Long Distance Remote Vehicle Disabler as claimed in claim 16 comprises,
the disable button being positioned on the front face of the remote casing;
the enable button being positioned on the front face of the remote casing adjacent to the disable button;
the disable button being connected to the transmitter; and
the enable button being connected to the transmitter.

18. The Parking and Long Distance Remote Vehicle Disabler as claimed in claim 16 comprises,
the back face comprises of a battery compartment and a battery cover;
the battery compartment being a recessed space positioned on the back face;
the remote battery being positioned and secured in the battery compartment by the battery cover; and
the transmitter being connected to and powered by the remote battery.

19. The Parking and Long Distance Remote Vehicle Disabler as claimed in claim 16 comprises,
the RF receiver being positioned inside the device casing;
the switch being positioned inside the device casing; and
the switch being connected to the RF receiver.

20. The Parking and Long Distance Remote Vehicle Disabler as claimed in claim 16 comprises,
the power lead connecters being extended from the device casing;
a pair of mounting eyelets protruding from the device casing; and
the essential vehicle component being a car part selected from the group consisting of a distributor, ignition coil, fuel pump, and fuel injector.
